(19) United States
(12) Patent Application Publication
(10) Pub. No.: US 2008/0213031 A1
(43) Pub. Date: Sep. 4, 2008

(54) Point for writing instrument, drawing instrument and/or marking instrument

(76) Inventors: Arno Castner, Ruckersdorf (DE); Vyhnal Alexander, Nurnberg (DE)

Correspondence Address: Friedrich Kueffner, Suite 910, 317 Madison Avenue, New York, NY, 10017, US

(21) Appl. No.: 12/070,343

(22) Filed: Feb. 14, 2008

(30) Foreign Application Priority Data
Feb. 20, 2007 (DE) 10 2007 008 352.3

(51) Int. Cl. B43K 1/00

(52) U.S. Cl. 401/292

(57) ABSTRACT

A point for writing instruments, drawing instruments and/or marking instruments has at least one marking edge, wherein the at least one marking edge has at least one recessed area, and wherein the at least one recessed area is configured between two elevated points.

### BACKGROUND OF THE INVENTION

1. Field of the Invention

The present invention relates to a point for a writing instrument, drawing instrument and/or marking instrument, in particular to points for marking instruments, also known under the name of “text markers”.

2. Description of the Related Art

Points for marking instruments are known in principle. Such points are mostly made from sintered plastics powder or from fiber material, wherein the fiber material is normally available as glued fiber bundle, which is brought into a particular form and is subsequently ground, where necessary.

Every one of these points, for example, sintered plastics points or fiber points made of directed nylon fibers, polyester fibers or acrylic fibers, display in use their advantages and disadvantages, for example, in their viscosity, their resistance/durability or their ink flow.

As a disadvantage it has been noticed in such points that these points during critical use like, for example, during marking of inkjet down-strokes, lead to considerable smearing of the down-strokes on a medium, for example, on paper. This smearing is caused mainly by an abrasion effect which is always present in the overcoating of a down-stroke with the rough marker points, when the point glides over the down-stroke. This above-described gliding could be compared to overcoating the down-stroke with fine grain sandpaper, wherein the sandpaper releases color mediums or colored medium particles from the compound and drags them along. This effect is enhanced when the bearing pressure of the point on the medium is increased during the process of overcoating.

Although it appears that the sintered points, due to a smoother surface structure, convey a softer marking sensation or writing sensation compared to fiber points, and although during overcoating of an inkjet down-stroke on the medium causes less smearing, the marking with sintered points, nevertheless, is often enough not satisfactory for the user, at the latest when the down-stroke is particularly sensitive or when copies are made of thus marked texts and the marked areas appear as grey or dark grey bars.

Moreover, an ink is known from DE 101 55 863 A1 which is composed in such a manner that down-strokes produced from watery pigmented inkjet inks smear very little during overcoating, i.e., during marking and highlighting with text markers. In this case a reduction in the smearing is obtained through a chemical precipitation reaction between the marking ink of the pen and the components of the inkjet down-stroke.

It is considered disadvantageous in such systems that through these special inks in text markers only in some down-strokes, down-strokes of a special composition, an improved effect regarding the smearing can be achieved, or the effect is strongly dependent on the dryness of the down-stroke as well as the paper consistency. A universal solution of the problem is not given in DE 101 55 863 A1.

### SUMMARY OF THE INVENTION

It is, therefore, the object of the present invention to create a point that does not have the disadvantages mentioned above and that shows a reduced abrasion behavior towards a down-stroke on a print medium, independent from the kind of down-stroke. Moreover, it is the object of the present invention to create a point for marking instruments that show an improved sliding performance on the print medium, independent from the fact whether the surface of the medium is smooth or rough.

In accordance with the present invention, the contour of a point is designed and/or configured in such a manner that the sensitive down-stroke on the print medium is mechanically strained as little as possible during overcoating with the point of a marking instrument and thus the abrasion phenomenon is strongly reduced.

The contour of a writing point, a so-called Meisel point or suchlike, was configured in such a way that the edge which dispenses the fluid marking medium onto the print medium, for example, an ink, is not configured as a straight edge, but rather has recessed areas which are configured, for example, concavely, or concavely arched.

It has been proven as particularly advantageous when the recessed areas of the point are configured as a kind of saddle contour, in which at least one concave area is formed between two saddle points. In the saddle contour the edges of the point are rounded towards the flanks, which leads to the fact that good gliding properties are maintained independent from the writing angle.

The decisive advantage of a concave or slightly concavely arched marking edge is to be seen in the fact that the border areas of the point, the elevated saddle points of the writing point according to the state of the art, indeed still act abrasively upon the surface of the medium, however, the area between the saddle points glides almost pressureless and/or contactless over the down-stroke. In this manner, the smearing is greatly reduced, in fact almost reduced to zero.

In the best case, there is contactless marking, when the contour is configured concavely in such a manner that between the saddle points of the point bearing on the medium and between the concavely configured contour and the medium, an ink meniscus is formed. Thus, in the area between the saddle points, the marking is contactless and therefore without abrasion.

In order to guarantee the effect reached by way of the present invention also during slightly increased contact pressure of the point onto the medium through the user, the point should have a good strength of shape which is measured in such a manner that at all times during marking the point has a slightly concave marking edge.

In unfavorable cases, a slight smearing in the border areas of the marking stroke may occur, however, the positive visual impression of the areas marked with the concavely configured area of the point prevails, which appears clear and distinct.

It has been found that the attention of the user/spectator is concentrated before all on the center, for example, during reading, on the central area of the writing which is the least smeared when using the marking point according to the present invention.

It is to be mentioned as an example that texts printed with inkjet are mainly available in the font size 10 to 12. In an average marking width of the point according to the present invention of 5 mm, the contact points between the saddle points of the point and the medium lie mostly already outside of the printed text.

When using the point according to the present invention, it surprisingly appears that, during marking on low suction print media, wherein the inkjet ink and/or the writing instrument ink does not permeate the medium, but is rather arranged almost unprotectedly on the surface, a mechanical smearing or smudging can be almost avoided.

In addition, it has been discovered that a point according to the present invention consisting of sintered polyethylene has a significantly better gliding behavior than a point that has no recessed areas.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE DRAWING

In the drawing:

FIG. 1 is a perspective view of a point according to the invention;

FIG. 2 is a side view according to FIG. 1 of the point according to the invention;

FIG. 3 is a top view of the point according to FIG. 1;

FIG. 4 is a view of the point according to the invention interacting with a medium;

FIG. 5 is a perspective view of an alternative embodiment of the point according to the invention.

### DESCRIPTION OF PREFERRED EMBODIMENTS

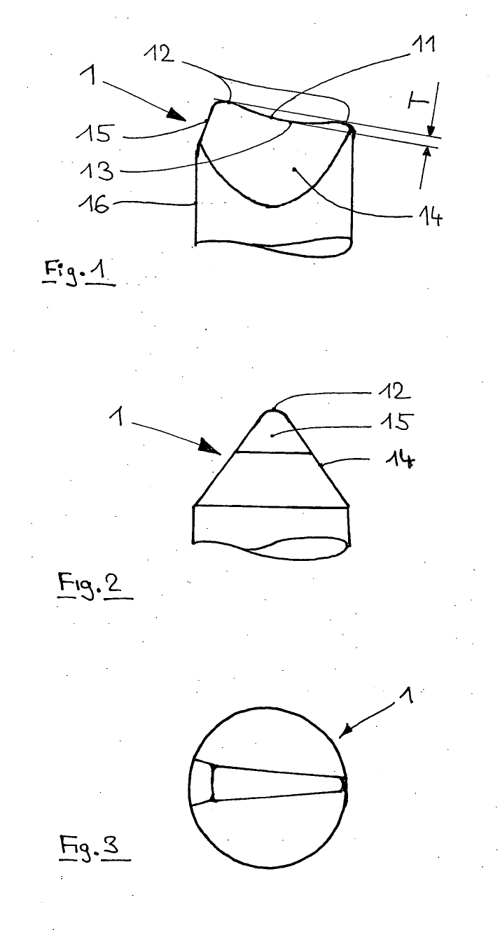

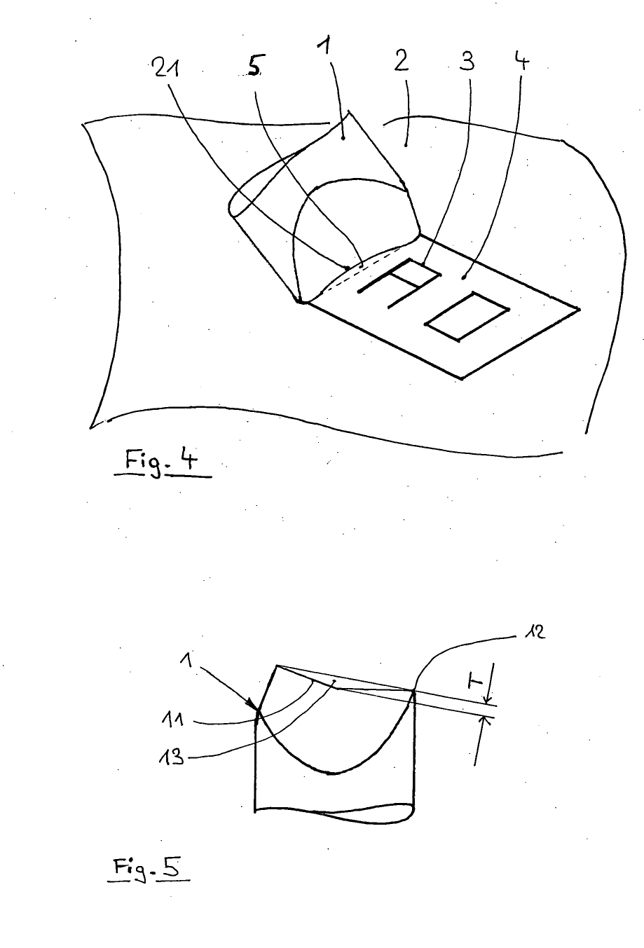

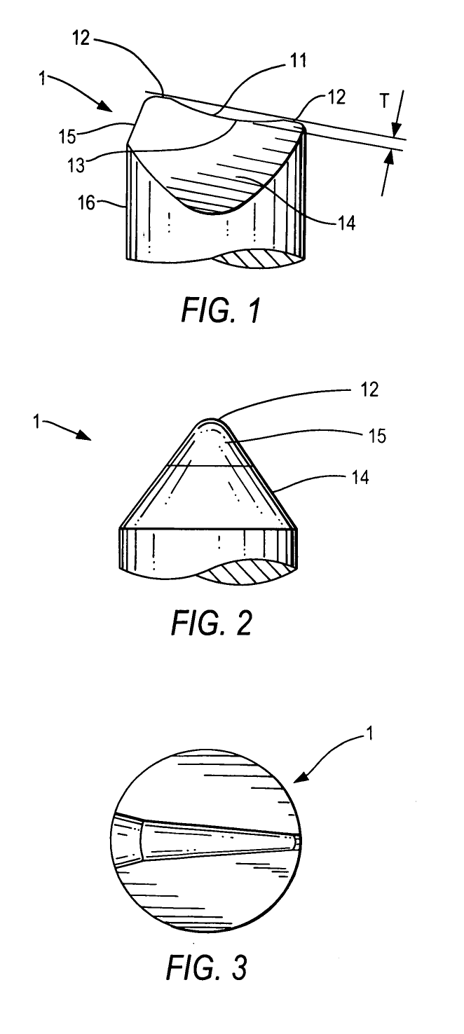

FIG. 1 shows the marking point 1 according to the present invention in the embodiment of a saddle point with saddle contour. The marking edge 11 of the point consists of the saddle points 12 and the recessed area lying therebetween, i.e., a concave area 13. The concave area 13 has a recess of the depth T opposite an imagined line between the saddle points 12. In order to guarantee good sliding capability of the point 1 on a print medium, the saddle points 12 are rounded toward the flanks 14.

In this embodiment, the writing point has a flattened portion 15, wherein also in this case the passage between the saddle point 12 and the flattened portion 15 is configured in a rounded shape. Through such a design, hard crossovers in proximity of the marking edge 11 and the saddle points 12 are avoided and an optimum sliding capability is guaranteed.

In FIG. 1 it is not shown that the concave marking edge can also have recesses, for example, of jagged, undulating or suchlike design. The advantage of such a configuration could lie in the fact that in the recesses mentioned as an example due to capillarity, an ink meniscus forms in the recesses, which produces an even and covering marking during the marking process.

In FIG. 2 the point 1 according to the present invention according to FIG. 1 is illustrated. In this view, a saddle point 12, the flattened portion 15 and the flanks 14 can be seen as edges of the point 1. The passage between saddle point 12 and the marking edge 11 toward the flanks 14 is also configured in a rounded shape.

FIG. 3 shows the top view of the point 1 according to the invention according to FIGS. 1 and 2.

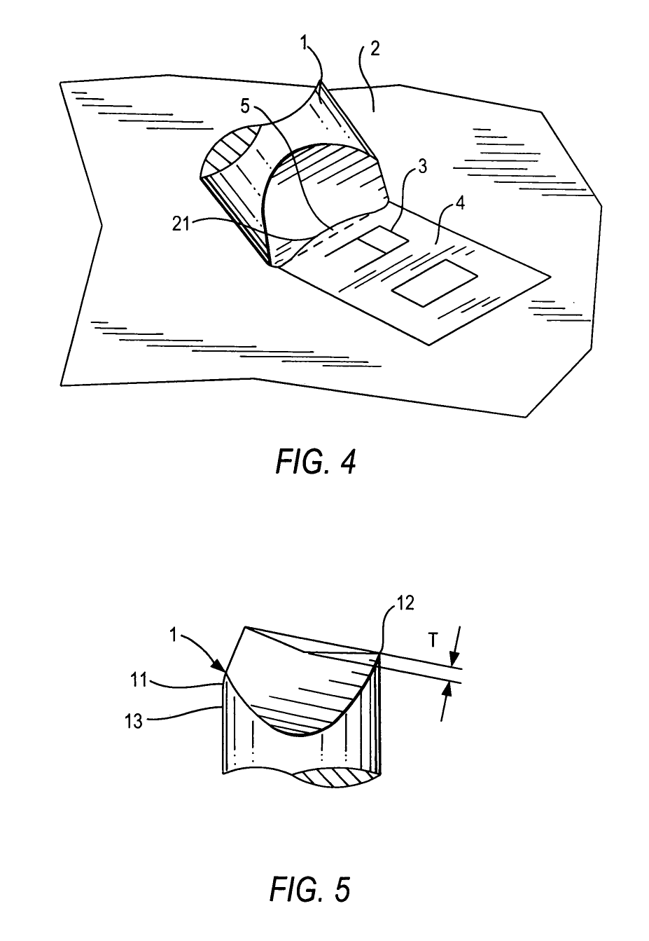

FIG. 4 shows the print medium 2, on which is arranged a down-stroke 3. With a point 1 a marking down-stroke 4 was produced over the down-stroke 3. Between the medium 2 and the marking edge 11 of the point 1, an ink meniscus 5 is formed.

In FIG. 5, an alternative embodiment of the point 1 according to the invention is illustrated. The marking edge 11 stretches between the two elevated points 12, wherein the marking edge 11 consists of two straight lines and a recessed area 13 of the depth T, that define the point geometry.

The point according to the present invention for writing instruments, drawing instruments and/or marking instruments has at least one marking edge, wherein the at least one marking edge has at least one recessed area that is formed between two elevated points. The area configured as a recess is formed, for example, as a concave area.

The elevated points can be configured as a kind of saddle points that are rounded toward all sides.

The recessed area has a depth T which is smaller than 1 mm.

The transition between the marking edge and the flanks of the point is preferably configured as rounded, and also the transition between the elevated points and the flattened portions, the flanks and/or the outer surfaces of the point are preferably configured as rounded. The point can consist, for example, of sintered plastics material or of fiber material

While specific embodiments of the invention have been shown and described in detail to illustrate the inventive principles, it will be understood that the invention may be embodied otherwise without departing from such principles.

1. A point for writing instruments, drawing instruments and/or marking instruments, the point comprising at least one marking edge, the at least one marking edge having at least one recessed area, and the at least one recessed area being configured so as to extend between two elevated points.

2. The point according to claim 1, wherein the at least one recessed area is configured as a concave area.

3. The point according to claim 1, wherein the elevated points are configured as saddle points.

4. The point according to claim 1, wherein the at least one recessed area has a depth that is smaller than 1 mm.

5. The point according to claim 1, wherein transitions between the marking edge and the flanks of the point are of rounded configuration.

6. The point according to claim 1, wherein transitions between the elevated points and the flattened portions, the flanks and/or the outer surfaces of the point are rounded.

7. The point according to claim 1, wherein the point is of plastics material.

8. The point according to claim 1, wherein the point consists of fiber material, and the fiber material is comprised of directed polyester fibers or polyacrylic fibers.
